(19) United States
(12) Patent Application Publication
(10) Pub. No.: US 2013/0111330 A1
(43) Pub. Date: May 2, 2013

(54) ACCELERATED COMPOSITING OF FIXED POSITION ELEMENTS ON AN ELECTRONIC DEVICE

(71) Applicants: George Ross STAIKOS, Toronto (CA); Karl Arvid NILSSON, Lund (SE); Jeremy Alexander NICHOLL, Waterloo (CA); Eli Joshua FIDLER, Toronto (CA)

(72) Inventors: George Ross STAIKOS, Toronto (CA); Karl Arvid NILSSON, Lund (SE); Jeremy Alexander NICHOLL, Waterloo (CA); Eli Joshua FIDLER, Toronto (CA)

(73) Assignee: RESEARCH IN MOTION LIMITED, Waterloo (CA)

(21) Appl. No.: 13/286,581

(22) Filed: Nov. 1, 2011

(51) Int. Cl. G06F 17/21

(52) U.S. Cl. 715/241

(57) ABSTRACT

A device, system and method are provided for processing structured documents for display. Content of a first viewable portion of the structured document having a fixed position in relation to a viewport is rendered as first rendered image data. Content of a second viewable portion that does not have a fixed position is rendered as second rendered image data. The first and second rendered image data are composited, and a resultant composited image is output for display. In response to a scroll or zoom command applied to the document, and in particular to the second viewable portion, the second rendered image data is updated and composited with the first rendered image data. Compositing can be carried out by a graphics processor separate from a main processor in the electronic device. When no fixed position elements are present in the structured document, the main processor renders the entire content without compositing.

### BACKGROUND

1. Technical Field

The present application relates to the accelerated processing and display of structured document data including fixed position elements.

2. Description of the Related Art

Web browsers, word processors, e-book readers and similar applications are used to present structured documents, webpages, HTML files, and the like, for display by an electronic device. The content of a structured document may be associated with presentation or style directives relating to the formatting and appearance of the content, and in particular to the position of displayable content elements within the structured document when it is rendered for display. These directives may be included within the document itself, or provided in a separate file associated with the document. A possible style directive defines the element position as “fixed” with reference to an available viewport for the application rendering the structured document, such as an application window displayed on a display screen for the electronic device. When the structured document is rendered for display, any displayable content elements of the structured document that are fixed in position are processed such that they are presented in the specified fixed position, and other non-fixed elements are processed according to any other applicable style directives that may define their positions with reference to each other or to the rendered structured document as a whole. The complete rendered structured document with both fixed and non-fixed rendered elements is then sent to the display in the form of image data in accordance with the requirements of the electronic device's display interface.

The position of a “fixed” element of the structured document remains constant in relation to the viewport regardless of any positioning change to the non-fixed elements; thus, if a command is received to scroll the rendered structured document as it is displayed in the viewport, the fixed elements remain in their original position with reference to the viewport, while the position of the other elements change with reference to the viewport. Therefore, whenever an instruction is processed that changes the position of the non-fixed elements, the entire image data representing the rendered structured document must be updated, and the updated image data sent to the display. This updating consumes processor and memory overhead on the electronic device.

### BRIEF DESCRIPTION OF THE DRAWINGS

In drawings which illustrate by way of example only embodiments of the present application and in which like reference numerals describe similar items throughout the various figures,

FIG. 1 is a block diagram of an embodiment of an electronic device.

FIG. 2 is a schematic diagram of select components of the electronic device of FIG. 1.

FIG. 3A is a schematic diagram of a structured document with a viewport in a first position.

FIG. 3B is a further schematic diagram of the structured document of FIG. 3A with the viewport in a second position.

FIG. 3C is a still further schematic diagram of the structured document of FIG. 3A including a fixed position element with the viewport in the second position.

FIG. 4A is an illustration of a structured document rendered and displayed on an electronic device.

FIG. 4B is a further illustration of the structured document of FIG. 4A after a change to the content displayed in the viewport is detected.

FIG. 5A is a schematic diagram of the structured document of FIG. 4A.

FIG. 5B is a schematic diagram of the structured document of FIG. 4B.

FIG. 6 is a flowchart illustrating a process of processing a structured document for output to a display interface.

FIG. 7 is a flowchart illustrating a process of compositing structured document data by a graphics processor module.

FIG. 8 is a flowchart illustrating a process of updating display of a structured document in response to a detected change.

FIG. 9 is a flowchart illustrating a process of updating rendered image data in response to a detected change.

FIG. 10 is a flowchart illustrating a process of updating rendered image data in response to a further detected change.

FIG. 11 is a flowchart illustrating a process of selectively processing a structured document.

### DETAILED DESCRIPTION OF THE INVENTION

The embodiments herein provide improved devices, systems, methods and computer program products for rendering and displaying structured documents, such as webpages, including one or more fixed position elements through accelerated compositing using a graphics processor module.

These embodiments will be described and illustrated primarily in relation to electronic devices adapted to process input files for display via a display interface, optionally including an integrated display screen. Examples of such electronic devices include tablet computing devices and smartphones. It will be appreciated by those skilled in the art, however, that this description is not intended to limit the scope of the described embodiments to implementation on these particular types of devices. The embodiments described herein may be applied to any appropriate electronic device, which may be adapted to communicate with another electronic device over a fixed or wireless connection, whether portable or wirelessly enabled or not, and whether provided with voice communication capabilities or not. The electronic device can be adapted to process data and carry out operations on data in response to user commands for any number of purposes, including productivity and entertainment. Thus, the embodiments described herein may be implemented on electronic devices adapted for content browsing, communication or messaging, including without limitation the above-mentioned tablets and smartphones as well as cellular phones, wireless organizers, personal digital assistants, desktop computers, terminals, laptops, handheld wireless communication devices, notebook computers, ebook readers, entertainment devices such as MP3 or video players, and the like. Unless expressly stated, an electronic device may include any such device.

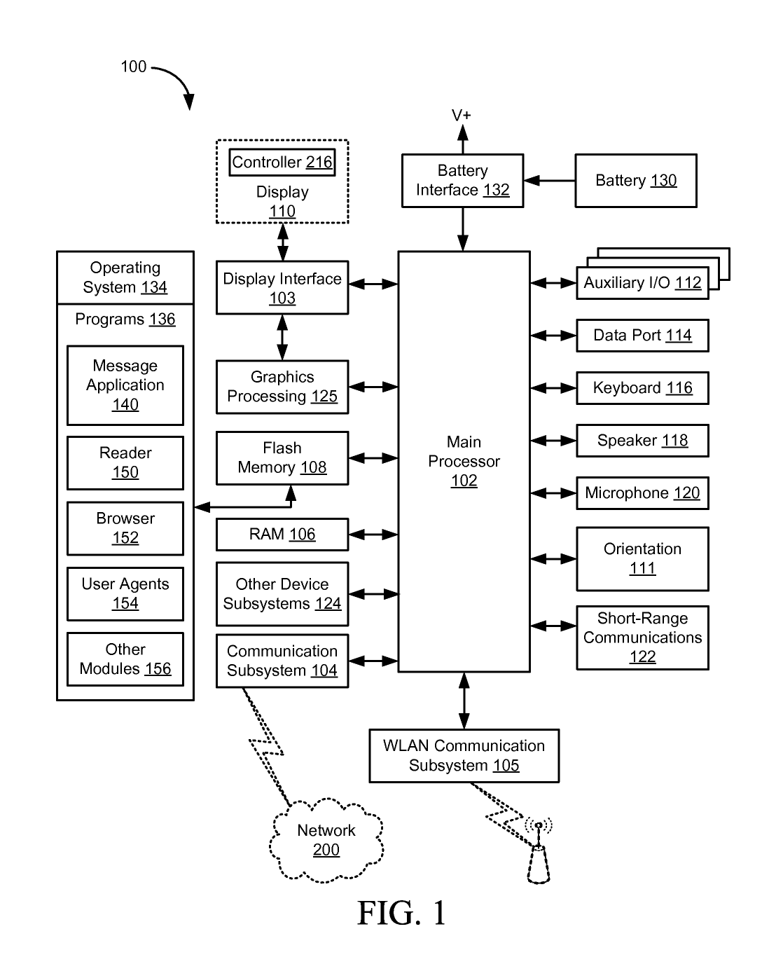

FIG. 1 is a block diagram of an example embodiment of an electronic device 100 that may be used with the embodiments described herein. The electronic device 100 includes a number of components such as a main processor 102 that controls the overall operation of the electronic device 100. It should be understood that the components described in FIG. 1 are optional and that an electronic device used with various embodiments described herein may include or omit components described in relation to FIG. 1.

The electronic device 100 may be a battery-powered device including a battery interface 132 for receiving one or more rechargeable batteries 130. Communication functions, including data and voice communications, are performed through one or more communication subsystems 104, 105, and/or 122 in communication with the processor 102. Data received by the electronic device 100 can be decompressed and decrypted by a decoder, operating according to any suitable decompression techniques, and encryption/decryption techniques according to one or more various encryption or compression standards known to persons of skill in the art.

If equipped with a communication subsystem 104, this subsystem 104 receives data from and sends data to wireless network 200. In this embodiment of the electronic device 100, the communication subsystem 104 is configured in accordance with one or more wireless communications standards. New wireless communications standards are still being defined, but it is believed that they will have similarities to the network behaviour described herein, and it will also be understood by persons skilled in the art that the embodiments described herein are intended to use any other suitable standards that are developed in the future. The wireless link connecting the communication subsystem 104 with the wireless network 200 represents one or more different Radio Frequency (RF) channels, operating according to defined protocols specified for the wireless communications standard, and optionally other network communications.

The electronic device 100 may be provided with other communication subsystems, such as a wireless LAN (WLAN) communication subsystem 105 or a short-range and/or near-field communications subsystem 122 also shown in FIG. 1. The WLAN communication subsystem 105 may operate in accordance with a known network protocol such as one or more of the 802.11™ family of standards developed or maintained by IEEE. The communications subsystems 105 and 122 provide for communication between the electronic device 100 and different systems or devices without the use of the wireless network 200, over varying distances that may be less than the distance over which the communication subsystem 104 can communicate with the wireless network 200. The subsystem 122 can include an infrared device and associated circuits and/or other components for short-range or near-field communication.

It should be understood that any of the communication subsystems 104, 105, 122 may optionally be included in the electronic device 100. Alternatively, a communication subsystem provided in a dongle or other peripheral device (not shown) may be connected to the electronic device 100, either wireles sly or by a fixed connection such as a USB port, to provide the electronic device 100 with access to a network. If provided onboard the electronic device 100, the communication subsystems 104, 105 and 122 may be separate from, or integrated with, each other.

The main processor 102 also interacts with additional subsystems such as a Random Access Memory (RAM) 106, a flash memory 108, a display interface 103, other data and memory access interfaces such as an auxiliary input/output (I/O) subsystem 112 or a data port 114, a keyboard 116, a speaker 118, a microphone 120, the short-range communications 122 and other device subsystems 124. The communication device may also be provided with an accelerometer 111, which may be used to detect gravity- or motion-induced forces and their direction. Detection of such forces applied to the electronic device 100 may be processed to determine a response of the electronic device 100, such as an orientation of a graphical user interface displayed on the display 110 in response to a determination of the current orientation of the electronic device 100.

In some embodiments, the electronic device 100 may comprise an integral display screen 110, shown in phantom in FIG. 1. For example, a handheld or portable electronic device 100 such as a tablet, laptop, or smartphone typically incorporates a display screen 110 in communication with the main processor 102 via the display interface 103, whereas other electronic devices 100 are connected to external monitors or screens using the display interface 103, as in the case of a desktop computer. However, smaller devices, such as the tablet, laptop or smartphone, may also be connected to external monitors or screens, in which case the display interface 103 represented in FIG. 1 includes an interface for connection of an external display device. Thus, as contemplated herein, the electronic device 100 may have an integrated display interface, or may be configured to output data to be painted to an external display unit such as an external monitor or panel, television screen, projector, or virtual retinal display (via a data port or transmitter, such as a Bluetooth® transceiver, USB port, HDMI port, DVI port, and the like). References herein to a “display” and “display screen” are intended to encompass both integrated and external display units, and references to the “display interface” are intended to encompass interfaces for both integrated and external display units.

Further, in some embodiments, the display 110 may be a touchscreen-based device, in which the display 110 is a touchscreen interface that provides both a display for communicating information and presenting graphical user interfaces, as well as an input subsystem for detecting user input that may be converted to instructions for execution by the device 100. The display 110 may thus be the principal user interface provided on the electronic device 100, although in some embodiments, additional buttons, variously shown in the figures or a trackpad, or other input means may be provided. If a touchscreen is provided, then other user input means such as the keyboard 116 may or may not be present. The controller 216 and/or the processor 102 may detect a touch by any suitable contact member on the touch-sensitive display 110.

When a user specifies that a data file is to be outputted to the display interface 103, the data file is processed for display by the main processor 102. This processing may include, in the case of structured documents, parsing of the document to render the document or a portion thereof as an image file, which is then provided as output to the display interface 103 as discussed below. The main processor 102 may thus include a visualization subsystem, implemented in hardware, software, or a combination thereof, to process the data file for display.

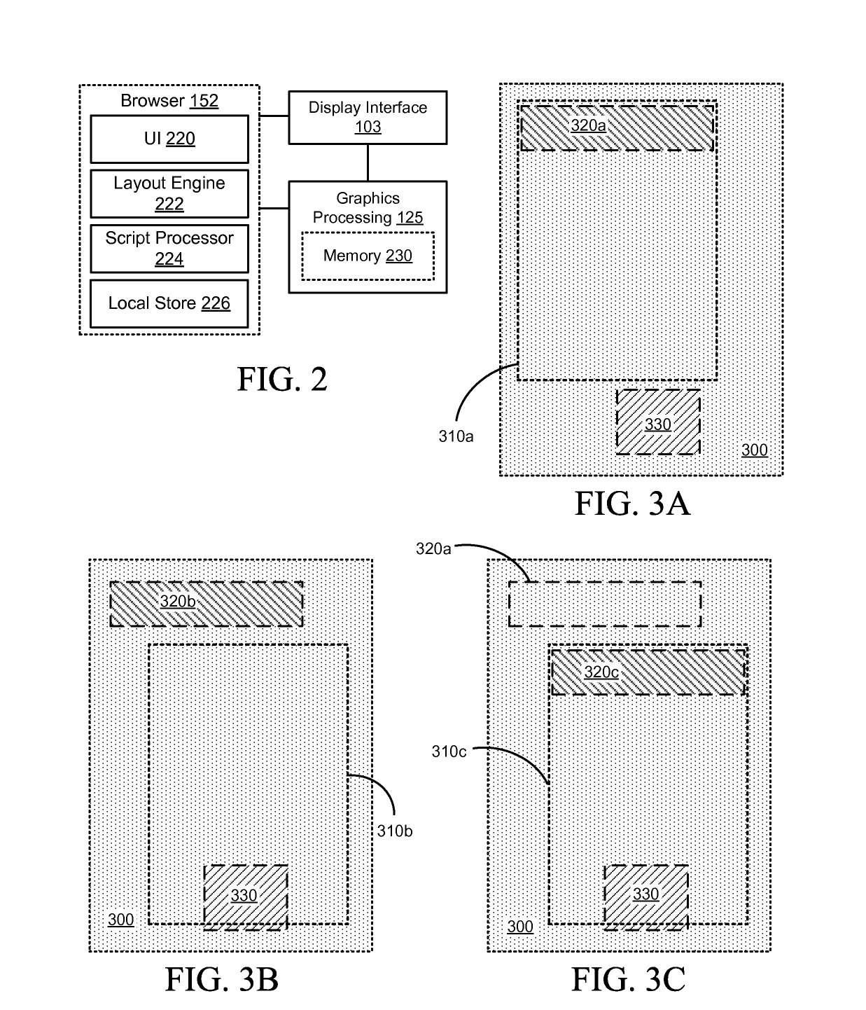

Depending on the input data file, the processing carried out by the processor 102 in preparation for display may be relatively intensive, and the processing may consume a significant amount of processor time and memory. In particular, processing data files originally optimized or prepared for visualization on large-screen displays on a portable electronic device display often requires additional processing prior to visualization on the small-screen portable electronic device displays. Thus, the electronic device 100 may also be provided with a graphics processor module 125 separate from the main processor 102, again implementable in hardware, software, or a combination thereof. The graphics processor module 125 may comprise a dedicated image processor with associated circuitry, including memory 230 (shown in FIG. 2) that is separate from other memory in the electronic device 100, such as the RAM 106, flash memory 108, and any memory internal to the main processor 102. The operation of such graphics processor modules will be known to those skilled in the art. Upon an application processing data file for display determining that the file includes content or transformations that are appropriately handled by the graphics processor module 125, those components of the file are provided to the graphics processor module 125 with associated commands for the rendering of that content for output to the display interface 103. The graphics processor module 125 can be configured to retrieve image files stored in device memory (such as RAM 106 or flash memory 108), or in its own resident memory 230, and to apply these image files as texture maps to surfaces defined in accordance with the received commands.

The electronic device 100 also includes an operating system 134 and software components 136 to 156 which are described in more detail below. The operating system 134 and the software components 136 to 156 that are executed by the main processor 102 are typically stored in a persistent store such as the flash memory 108, which can alternatively be a read-only memory (ROM) or similar storage element (not shown). Those skilled in the art will appreciate that portions of the operating system 134 and the software components 138 to 152, such as specific device applications, or parts thereof, can be temporarily loaded into a volatile store such as the RAM 106. Select other modules 152 may also be included, such as those described herein. Other software components can also be included, as is well known to those skilled in the art.

The subset of software applications 136 that control basic device operations, including data and voice communication applications, will normally be installed on the electronic device 100 during its manufacture. Other software applications include a message application 138 that can be any suitable software program that allows a user of the electronic device 100 to send and receive electronic messages. Various alternatives exist for the message application 138 as is well known to those skilled in the art. Messages that have been sent or received by the user are typically stored in the flash memory 108 of the electronic device 100 or some other suitable storage element in the electronic device 100. In at least some embodiments, some of the sent and received messages can be stored remotely from the electronic device 100 such as in a data store of an associated host system with which the electronic device 100 communicates.

Other types of software applications can also be installed on the electronic device 100, such as feed or content readers 150, web browsers 152, other user agents 154, and other modules 156. These software applications may be supplied by the electronic device manufacturer or operating system provider, or may be third party applications. Examples of applications include games, calculators, and utilities. The additional applications can be loaded onto the electronic device 100 through at least one of the communications subsystems 104, 105, 122, the auxiliary I/O subsystem 112, the data port 114, or any other suitable device subsystem 124. This flexibility in application installation increases the functionality of the electronic device 100 and can provide enhanced on-device functions, communication-related functions, or both.

In use, a received signal such as a text message, an e-mail message, or webpage download will be processed by the receiving communication subsystem 104, 105, 122 and input to the main processor 102. The main processor 102 will then process the received signal for output via the display interface 103 or alternatively to the auxiliary I/O subsystem 112. A user can also compose data items, such as e-mail messages, for example, using the keyboard 116 in conjunction with the display 110 and possibly the auxiliary I/O subsystem 112. The auxiliary subsystem 112 can include devices such as: a touchscreen, mouse, track ball, infrared fingerprint detector, or a roller wheel with dynamic button pressing capability. The keyboard 116 may be an alphanumeric keyboard and/or telephone-type keypad. However, other types of keyboards can also be used. A composed item can be transmitted over the wireless network 200 through the communication subsystem 104. It will be appreciated that if the display 110 is a touchscreen, then the auxiliary subsystem 112 may still include one or more of the devices identified above.

The communication subsystem component 104 may include a receiver, transmitter, and associated components such as one or more embedded or internal antenna elements, Local Oscillators (LOs), and a processing module such as a Digital Signal Processor (DSP) in communication with the transmitter and receiver. The particular design of the communication subsystems 104, 105, 122, or other communication subsystem is dependent upon the communication network 200 with which the electronic device 100 is intended to operate. Thus, it should be understood that the foregoing description serves only as one example.

As noted above, the embodiments described herein relate to the processing of structured documents for presentation on a display. Structured documents can include documents authored using an SGML or XML-compliant, XML-like, or XML-based markup language, which, as those skilled in the art will appreciate, includes HTML-based documents such as webpages, and also includes web applications, other rich media applications, and widgets. The structured documents may include or be delivered in association with other elements such as scripts or rich media files, which can be delivered together with the structured document to the electronic device 100, or downloaded separately by the application for use when the structured document is rendered for display. These structured documents are processed and presented using applications such as the browser 152, content readers 150, messaging applications 140, and any other suitable user agent 154. In particular, the structured documents and applications described herein may conform to known standards for the structure and presentation of content, in particular HTML4 and HTML5, published by the World Wide Web Consortium (W3C) at w3.org. In addition, the within embodiments may comply with companion, alternative, subsequent and predecessor standards and specifications, including without limitation other versions of HTML, XHTML 1.0 and 2.0, DOM Levels 1 through 3, and CSS Levels 1 through 3, also published by the World Wide Web Consortium (W3C) at w3.org.

While the embodiments herein are described primarily with reference to a browser application 152 and to webpages, it will be understood by those skilled in the art that these embodiments are not intended to be so limited, and are applicable to other types of structured documents and applications that generally conform to the embodiments herein. In particular, despite the particular examples of webpages employing CSS declarations to define attributes for various content elements, strict adherence to HTML or CSS standards is not mandatory; these embodiments may be implemented for the purpose of processing any suitable structured document that is capable of defining, or having defined for it, viewable portions having positions fixed in relation to a defined viewport.

Thus, a structured document, such as a webpage, may be retrieved by the electronic device 100 from memory at the device 100 such as the flash memory 108 or the RAM 106, or over a network connection such as the wireless network 200, from a network resource such as a web server. The webpage is then processed for display by the browser application 152. FIG. 2 illustrates select components of an electronic device 10 and of a web browser application 152 that may execute at the electronic device 100 for processing and rendering input webpages and other structured documents. The browser application 152 may include interoperating components such as a user interface engine 220, layout or rendering engine 222, a script processor, plug-in, or virtual machine 224 for executing code snippets, scripts and the like embedded in, received with, or invoked by the webpage being processed. The browser application 152 may also have its own local store 226, allocated to the application 152 from the volatile and/or non-volatile memory 106, 108 of the electronic device 100.

When a webpage is received or retrieved for processing and display, it is processed by the layout engine 222, with any scripts provided for the webpage passed to the script processor 224 for execution. The layout engine 222 parses the webpage to generate rendered document data which is ultimately output, after any further required processing by the main processor 102 or visualization subsystem, to the display interface 103. The techniques used by the layout engine 222 to prepare a rendered webpage are generally known in the art. In the embodiments herein, processing the input webpage to generate a rendered document for delivery to the display interface 103 is referred to as “preparing” or “rendering”, regardless how the processing of the webpage occurs. Generally, the rendering process includes parsing of the webpage, and construction of one or more models reflecting a hierarchical arrangement of nodes representing the various elements provided in the webpage. A model of the hierarchical arrangement is constructed in memory (e.g., the local store 226), to which model any defined styles are applied to determine the position and appearance of content elements of the webpage in the display view of the browser application 152. The content elements represented by the model, with their position and appearance as determined by the layout engine 222, are then painted to the display 110 via the display processor 103. Styles, scripts and similar data associated with various elements of the webpage and affecting the layout process may be included in the webpage provided to the electronic device 100, although in many cases such information may be provided in a separate file (such as a CSS file) that is identified in the header section of the webpage, and retrieved from the web server by the browser application 152. Alternatively, default styles defined at the browser application 152 may be applied to the webpage elements. When a content element in the webpage has an associated style parameter (either in the webpage itself or in a CSS file identified by the webpage) the style parameter is referred to herein as a style directive.

As noted above, performance on some electronic devices 100 may be adversely affected by relatively intensive processing of input data files for output to the display interface 103 for display. Thus, in mobile devices with limited processing power, it has been found advantageous to store the rendered webpage as a flat image file in the local store 226. The flat image file is a static “snapshot” of the rendered webpage at that point in time. For example, in many cases the content of a webpage is in fact greater in dimension than the viewport available for displaying the webpage on the display 110 particularly where the device in question is a smaller, portable device. The viewport may be defined not only by the operational region of the display 110, but also by the physical form factor of the device and the fit of the device chassis around the display 110. In some examples, the viewport dimensions are the same as the dimensions of the maximum physical display region of the display 110. The viewport may alternatively be defined by a window assigned by the device operating system 134 to the application presenting the webpage for display. The application window may be of variable size, and may be sized to be smaller than the dimensions of the rendered webpage. Thus, only a portion of the content of the webpage may be viewable at a given time.

The electronic device 100 may receive user instructions to display some of the content that is not currently viewable, such as a scroll or zoom command. The command is input by means of one or more user input devices or interfaces, including without limitation the keyboard 116, display 110 where it makes use of a touchscreen interface, microphone 120, trackball, buttons, trackpad, scroll wheel, optical joystick, rocker switch, and the like which may be external to or integrated with the electronic device 100. When the rendered webpage is already stored at the electronic device 100 as an image file, the image can be retrieved and a translation or scaling instruction applied. The data painted to the display 110 is then updated in view of the translation instruction. Without the image file, the layout engine 222 may be required to re-render the appropriate portion of the webpage for output to the display 110, thus increasing the burden on the processor 102.

Additional efficiencies can be realized by tiling the image in a backing store, which can be included in the local store 226. The backing store caches rendered structured document content for display. Implementation of a backing store is described in United States Patent Application Publication No. 2010/0281402 filed on Apr. 29, 2010, “Software-based Asynchronous Tiled Backingstore” and U.S. patent application Ser. No. 13/167,512, “Backing Store Memory Management for Rendering Scrollable Webpage Subregions” filed on Jun. 23, 2011, which are incorporated herein by reference.

The use of a flat image generated from the initially rendered webpage with or without a backing store, however, presents an incompatibility with style directives that define content elements as having a fixed position with reference to the viewport. As will be appreciated by those skilled in the art, style directives may be applied to define the positioning method of the elements within a webpage or other structured document. The position of an element can be defined with reference to the viewport itself (“fixed” positioning); with reference to an ancestor element within the webpage (“absolute” positioning); with reference to its position in normal document flow (“relative” positioning), or according to the default document flow order defined in the structured document (“static” positioning). The terms “fixed”, “absolute”, “relative”, and “static” are defined in the CSS specification. Examples of CSS style directives that define an element position as “fixed” include the {position: fixed}, {background-attachment: fixed} and {background: fixed} declarations. The latter two declarations define properties of a background of the webpage (e.g., “background-attachment” refers to an image that may be displayed as part of a background), while the former declaration may apply to any other content element.

A difference between fixed position elements and non-fixed position elements is that, to the viewer, the position of the fixed position element with reference to the viewport (i.e., the display 110 or the application window) should not change even when the webpage is scrolled, or other actions are taken that alter the positioning of other content elements in the webpage. By contrast, the position of absolute, relative and static position elements does change when the webpage is scrolled, because the position of these elements is constant with respect to the webpage itself, but not the viewport.

This difference is illustrated in FIGS. 3A through 3C, which represent schematics of a webpage rendered for display by an electronic device 100, where the viewport defined for display is smaller than the rendered webpage. In FIG. 3A, the complete rendered webpage is represented by block 300. The webpage 300 may contain various viewable portions containing content elements, including element 320a and element 330. The dimensions of the webpage 300 are defined either by style directives, or the webpage dimensions are determined by the dimensions required to accommodate all viewable content elements provided in the webpage.

The viewport available for displaying the rendered webpage 300, illustrated by box 310a, is smaller than the rendered webpage 300. As can be seen in FIG. 3A, the webpage 300 is positioned within the viewport 310a such that the element 320a is viewable in the viewport 310a but element 330 is not. If the element 320a or 330 is a “non-fixed” position element as discussed above (i.e., not a fixed position element, but instead a default (static), absolute or relative position element), their position will not change within the webpage 300 if the viewport 310a is simply translated to another position. This is illustrated in FIG. 3B, in which the position of the viewport has been moved to a new position, for example in response to a scroll or pan instruction, as shown by box 310b. The content of the webpage 300 now displayed in the viewport 310b may thus include content elements that were not previously viewable in the viewport 310a in FIG. 3A, including the element 330, but now excluding the element 320b since it is now beyond the bounds of the viewport 310b. The position of both elements 320b and 330 remains constant with reference to the bounds of the rendered webpage 300.

If the element 320a is defined as a fixed position element, a translation of the viewport will result in a change in the position of the element 320a with respect to the webpage 300 and any other non-fixed content elements contained therein. FIG. 3C illustrates the result of a translation of the viewport from its original position 310a in FIG. 3A to the new position 310c in FIG. 3C, when element 320a is a fixed position element and element 330 is not. Referring again to FIG. 3A, the position of the fixed position element 320a might be defined with a set of CSS declarations such as {left: Opx; top: Opx; position: fixed}, where the first two declarations position the element at an origin point of the viewport 310a (in this case the upper left-hand corner, and the third declaration defines the position of the element at that corner as “fixed”. It should be noted that in FIGS. 3A and 3C, the upper and left-hand bounds of the element 320a, 320c do not coincide exactly with the upper and left-hand bounds of the viewport 310a, 320c. Generally in the accompanying drawings, margins have been added to the bounds of select elements and portions so that their outlines can be more easily distinguished from one another. However, it will be understood from this description when those bounds are considered to be substantially coincident or aligned.

Thus, when the viewable portions of the webpage are rendered for display, the rendered webpage 300 will include a first viewable portion containing the fixed position element 320a, and a second viewable portion containing other elements that are not defined with fixed positions. If the entire webpage is rendered, the second viewable portion will include the element 330. Only those parts of the first viewable portion and second viewable portion that intersect the viewport 310a, however, will actually be displayed in FIG. 3A. The element 330 therefore would not be displayed at this stage. In this example, the viewport dimensions are determined by the available display area on an electronic device 100 with an integrated display (such as a tablet computing device), but the viewport may be defined by the dimensions of an application window displayed on only a portion or sub-area of a display screen.

When the viewport is translated to the new position 310c shown in FIG. 3C, again, the element 330 is now displayed since its position now intersects the viewport 310c. However, because element 320a is a fixed position element, its position remains at the upper left-hand corner of the viewport 310c, despite the translation of the viewport. Consequently, the element is now located at 320c, which is fixed in relation to the viewport, but is a change in position in relation to the rendered webpage 300 as a whole and to the non-fixed position element 330.

It will be understood by those skilled in the art that in some circumstances, changes to the viewport defined for the browser may result in a change to the positioning of the non-fixed position elements in the webpage with respect to one another or to the webpage itself. For example, if the viewport is defined by a browser window, a change to the viewport will result if the window is resized. However, a simple translation of the viewport as illustrated in FIGS. 3A through 3C typically does not result in a change to the positioning of non-fixed elements.

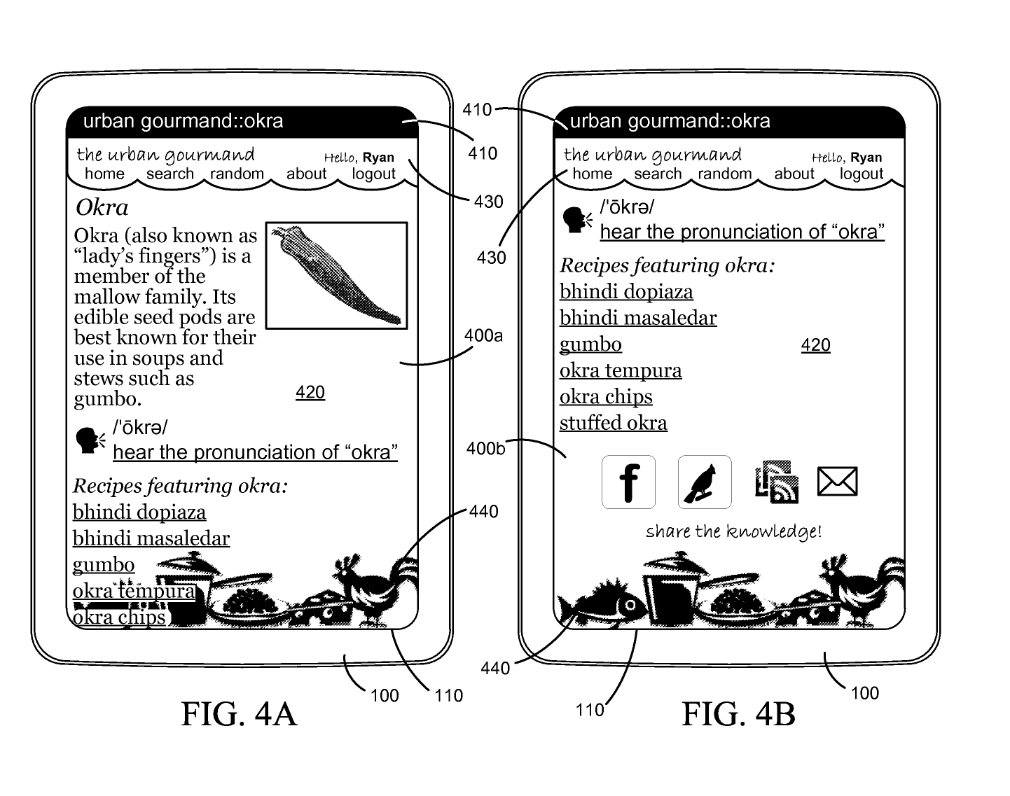

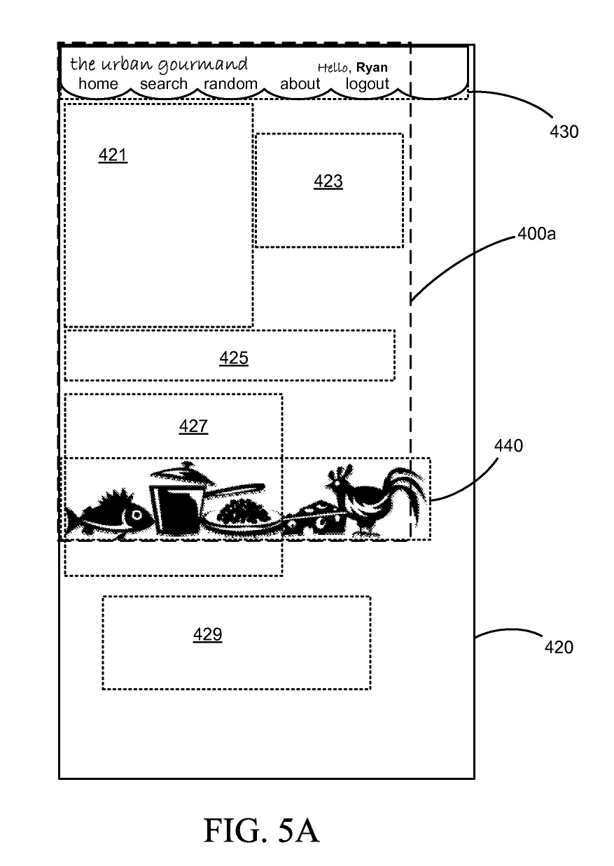

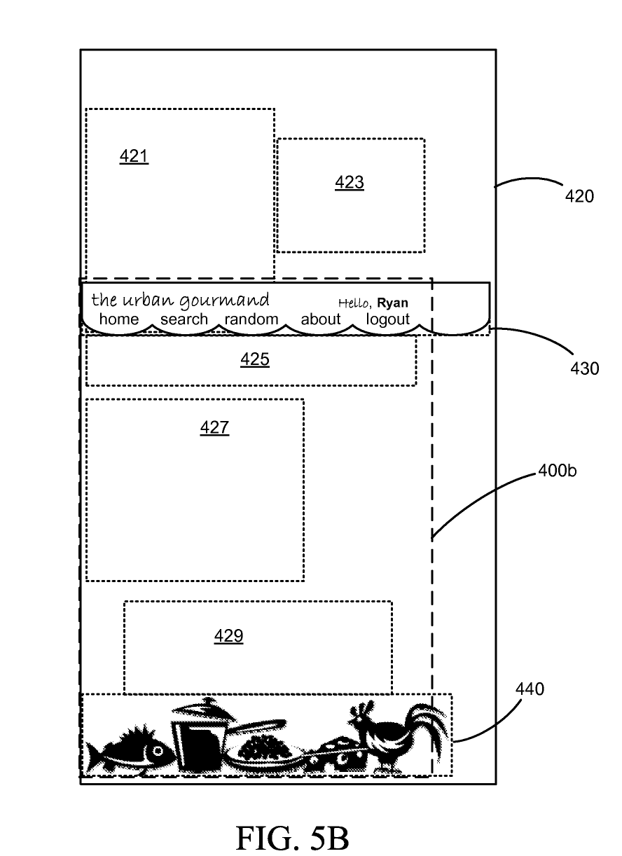

A further example of fixed position elements in a webpage is illustrated in FIGS. 4A through 5B. FIGS. 4A and 4B illustrate two views of a webpage rendered for display on an electronic device display 110. In FIG. 4A, a portion of the webpage is shown within the viewport 400a. The viewport 400a in this example does not fill the entire area of the display 110, but rather fills a sub-area of the display 110 beneath a title banner 410. The title banner 410 may be presented as part of the browser chrome. Depending on the configuration of the browser application 152 and/or the operating system 134, additional browser application features may be displayed, such as a horizontal or vertical scrollbar, which both visually indicates that there is additional webpage content for the currently displayed webpage not currently visible on the display 110, and provides a graphical user interface for receiving scroll commands. These additional features may further reduce the viewport dimensions.

The webpage of FIG. 4A includes a number of content elements that are viewable when the webpage is rendered, including non-fixed position elements within the portion 420 and two fixed position elements 430, 440. The first fixed position element 430 is located at the upper bound of the viewpoint 400a; for example, it may be positioned at the upper left-hand corner of the viewport 400a. In this example, the first fixed position element 430 is a navigation bar for a website. It is thus preferable that the element 430 remain in the same position regardless of any scrolling or other manipulation of the webpage, hence the use of fixed positioning. A second fixed position element 440 is positioned at the bottom of the viewport 400a, for example at the lower left-hand corner. In the example of FIG. 4A, the second fixed position element 440 is a decorative image arranged so that other content of the webpage overlays the element 440.

When the webpage is scrolled, as shown in FIG. 4B, the viewport 400b maintains the same dimensions, but it is now positioned over another portion of the webpage. Thus, the first and second fixed position elements 430, 440 remain in the same position, but the remainder of the webpage has now changed, such that the first fixed position element 430 now overlays some of the content of the remaining portion of the webpage 420.

The effect of moving the viewport from 400a to 400b is further illustrated by the schematics of FIGS. 5A and 5B, which correspond to FIGS. 4A and 4B. As can be seen in FIG. 5A, the webpage 420, when initially rendered, includes the fixed position elements 430, 440 as well as a number of other elements 421, 423, 425, 427, which correspond to the text, image, and hyperlink content elements displayed in FIG. 4A, since they intersect the viewport 400a. A further element 429, which is beyond the viewport 400a in this initial view of the webpage, is not visible in FIG. 4A.

In response to a command to scroll the webpage displayed in the display 110, the viewport 400a is moved to its new position 400b, as shown in FIG. 5B. Because the elements 430, 440 are fixed position elements, these elements also move with the viewport so that their position, which is constant with reference to the viewport 400b, is maintained. The remaining elements 421, 423, 425, 427, and 429, however, remain in their previous position within the webpage portion 420.

Other webpage features that may be preferable to maintain in position using fixed positioning can include tickers, virtual game consoles, and status bars. Fixed position elements need not be positioned at a boundary of the viewport, as in the examples herein; a fixed position element may be positioned in the center of the viewport, for example. Further, while the first fixed position element 430 in FIG. 4A and 4B overlays other content of the webpage, not every fixed position element need overlay the non-fixed position content. As shown in FIG. 4A, the second fixed position element 440 is rendered in the background, with other non-fixed content elements overlaying the element 440. When elements of a webpage are superimposed over other elements, the order in which various content elements (whether fixed position or not) are layered may be defined in default order (i.e., each subsequent element introduced in the webpage overlays a previous element), or alternatively by defining a stack order (as defined by a CSS style directive, a “z-index”) for one or more elements. Thus, the position of a fixed position element may be defined by assigning it a higher or lower stack order than other elements in the webpage.

Returning to the example of FIGS. 3A to 3C, had an image of the webpage shown therein been generated and stored when the webpage was initially rendered for display as described above, the image would resemble the schematic of FIG. 3A. If the element 320a were not a fixed position element, the stored image could be used to update the image painted to the display when the viewport was moved to the position 310b of FIG. 3B, effectively in a render-once, display-many scheme; all elements on the webpage 300 are in the same relative positions to one another. However, the introduction of the fixed position element renders the flat image generated based on the schematic of FIG. 3A obsolete when the viewport is moved to position 310c of FIG. 3C. The flat image, generated at the point in time of FIG. 3A when the viewport was in its original position 310a, no longer corresponds to the rendered webpage 300 of FIG. 3C since the fixed position element 320c has moved with respect to the webpage bounds and the other non-fixed position element.

The use of fixed position elements thus requires additional processing on the part of the layout engine 222 to regenerate the image of the rendered webpage so that it may be re-painted to the display 110. Thus, every time a scroll instruction is detected, the layout engine 222 must re-process the webpage in response to every scroll increment. If the processor 102 is not equipped to handle this additional processing, the display of the webpage while scrolling may appear “choppy”, or discontinuous. If the browser application 152 is configured to apply received zoom in/out commands to only the non-fixed content elements of a webpage, while leaving fixed position elements unscaled (or vice versa), then such commands can impose a similar burden on the layout engine 222.

Because this additional processing may be taxing to electronic devices 100 with limited processing power, browser applications 152 authored for such platforms either disable fixed positioning for elements, or implement workarounds that simulate fixed positioning. For example, if fixed positioning is disabled for an element, the element may either be removed from the render tree of the webpage altogether and not rendered for display at all, or else converted to an absolute position element, in which case its position would be constant with respect to the webpage, and it would scroll with the webpage. Disabling or redefining fixed positioning in this manner, however, may not be desirable. As shown in the example of FIG. 4A, the fixed position element may include a navigation bar. Its removal altogether would impair the user's access to that website via the navigation bar. Redefining the navigation bar as an absolute position element is more preferable, since the navigation bar would still be available. However, it may not be readily visible and accessible on the display if the viewport is moved away from the navigation bar position. Further, in the case of a fixed position element that is assigned a particular stack order to achieve a desired effect, such as the example of the element 440, altering the element to a different type of positioning may yield unexpected results.

Workarounds to simulate fixed positioning include a combination of treating the fixed position element as an absolute position element and re-rendering the webpage periodically or after the conclusion of scrolling. The fixed position element is converted to an absolute position element so that when the webpage is scrolled, the element scrolls with the remaining content. A stored flat image of the originally rendered webpage may thus be used during the entire scrolling action. Once the scrolling is complete, the layout engine 222 redetermines the proper position of the converted fixed position element in view of the new viewport position, and provides a re-rendered version of the webpage including that element for painting to the display. This workaround thus reduces the amount of processing that would otherwise be required for fixed position elements by combining it with the use of a stored image. While scrolling may appear smoother in this workaround, however, the webpage displayed while it is actively scrolling is actually obsolete since the ostensibly fixed position element is no longer in the correct position, and the sudden reappearance of that element in a new position after scrolling is completed may be visually distracting.

In short, attempts to address the problem of handling fixed position elements on mobile devices and devices with reduced processing power have involved removing potential user interaction with the fixed position element by removing the element completely, and/or making the browser or other application non-compliant with standard style directives such as {position: fixed}. However, by making use of the graphics processor module 125, compliance with such style directives can be preserved without significantly adding to the processing overhead generated by the layout engine 222. Rather than generating a single image file representing all viewable elements of a webpage, different sets of image data are generated for the fixed and non-fixed position elements. These different sets of image data are then composited using the graphics processor module 125 and sent to the display interface 103.

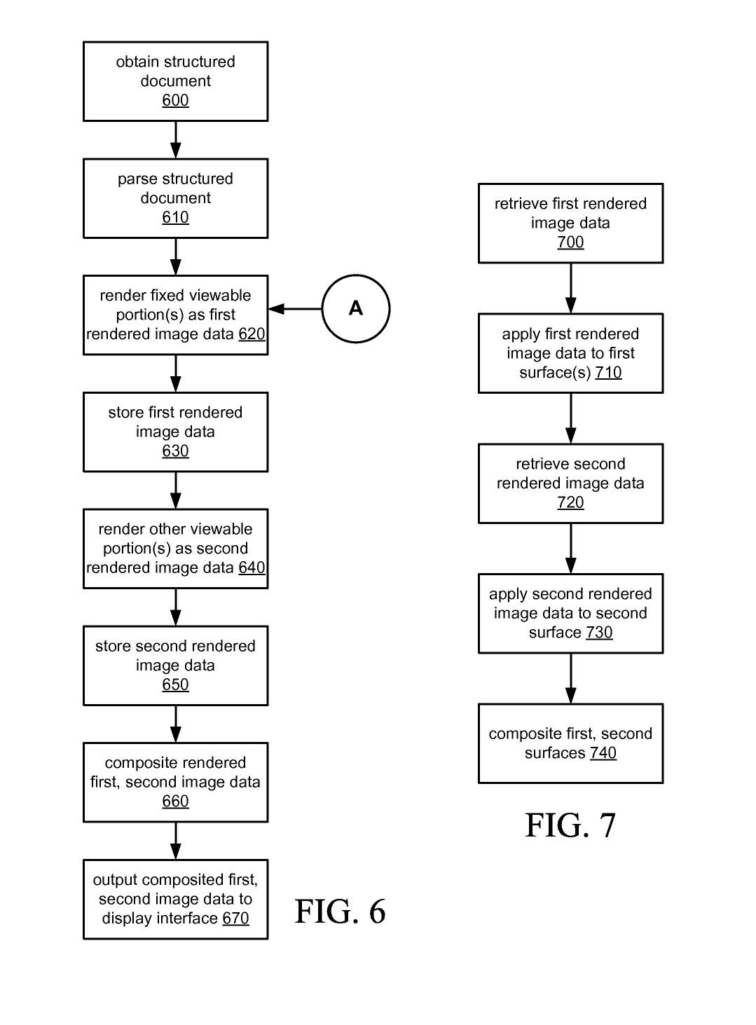

Turning to FIG. 6, a process for rendering a structured document such as a webpage containing at least one fixed element is shown. At 600, the structured document is obtained, as described above. At 610, the layout engine 222 parses the structured document, and identifies any viewable portions of the document containing fixed position elements. Any such viewable portions, since they contain a fixed position element, thus also have a fixed position with reference to the viewport. The fixed position elements are then rendered as first rendered image data at 620.

There may be more than one viewable portion fixed in position with reference to the viewport. Returning to the example of FIGS. 4A and 5A, there are two fixed position elements 430 and 440, and viewable portions are defined for each of them, each of these viewable portions having a fixed position with reference to the viewport. Thus, at 620, multiple first rendered images are generated. Where multiple fixed position elements have the same or adjacent positions in the stack order (z-indexes) defined for the webpage, they could be included within a single viewable portion, and a single first rendered image generated. In this example, however, the fixed position elements 430, 440 have different positions in the stacking order (as may be recalled from the above description, the second fixed position element 440 is layered beneath other non-content elements such as 421, 423, 425, 427, 429), so separate viewable portions are defined each fixed position element and two first rendered images are generated. The first rendered image data for each of the viewable portions is then stored at 630 in memory accessible to the graphics processor module 125. This memory may be shared memory in the RAM 106 or flash memory 108, or alternatively in the memory 230 comprised in or allocated to the graphics processor module 125. Stored data includes coordinates or other display position data for each viewable portion for use in subsequent compositing.

At 640, any remaining elements that do not have fixed positioning that are contained within a viewable portion of the structured document are rendered as second rendered image data, and stored separately in memory at 650. In the example of FIG. 5A, the remainder of the webpage content 420, including the elements 421, 423, 425, 427, 429 is included in this remaining viewable portion and second rendered image data. The second rendered image data may be stored in the same memory device as the first rendered image data; however, first and second rendered image data are maintained separately, i.e. not merged by the layout engine 222 into a file for a single image of the structured document. Since the fixed position elements in a webpage are typically removed from the normal document flow, rendering them as separate images does not affect the layout of the remaining, non-fixed position elements.

As noted above, a structured document such as a webpage, when rendered, may be larger in area than the available viewport. Thus, in some embodiments, only those portions of the document corresponding to the fixed and non-fixed position elements that are viewable in the viewport—that is to say, those elements that intersect the viewport in its current position—are rendered and stored, particularly if there is insufficient memory in the browser's local store 226 or backing store.

Once the first and second rendered image data have been rendered and stored, the graphics processor module 125 is instructed to composite the image data. The process of delivering instructions and data (e.g., via API calls, and so forth) to the graphics processor module 125 is implemented according to the graphics processor module specifications. Once the first and second image data have been composited by the graphics processor module 125, the composited data is output to the display interface 103, and thence to a display 110. The resultant composited image sent to the display 110 thus includes at least one first viewable region comprising fixed position elements, and having a fixed position with reference to the viewport, and a second viewable region corresponding to the non-fixed position elements of the structured document.

The compositing process is illustrated in further detail in FIG. 7. The instructions and data provided to the graphics processor module 125 include geometry information, such as display coordinates and/or bounding boxes of each layer or surface corresponding to each of the first and second image data, so that the graphics processor module 125 may correctly apply the first and second image data as textures to surfaces corresponding to each of the viewable portions of the structured document to create a composite image at 660. If multiple fixed position elements are included in a single first rendered image then the geometry information for that first rendered image data may include coordinates for each of the fixed position elements. The data may further include stack order information, such as z-indices, which are used by the graphics processor module 125 to determine the order of surfaces or layers during compositing. At 700, upon receipt of an instruction from the layout engine 222 or processor 102 to composite the first and second image data, the graphics processor module 125 retrieves the first rendered image data from memory, then applies it to a first surface at 710. The graphics processor module 125 then retrieves the second rendered image data at 720, and applies this second data to a second surface at 730. These first and second surfaces are then composited at 730 to yield the composited image for sending to the display interface 103. The graphics processor module 125 may be configured to discard any surfaces or portions of surfaces that are determined to be hidden by overlapping surfaces.

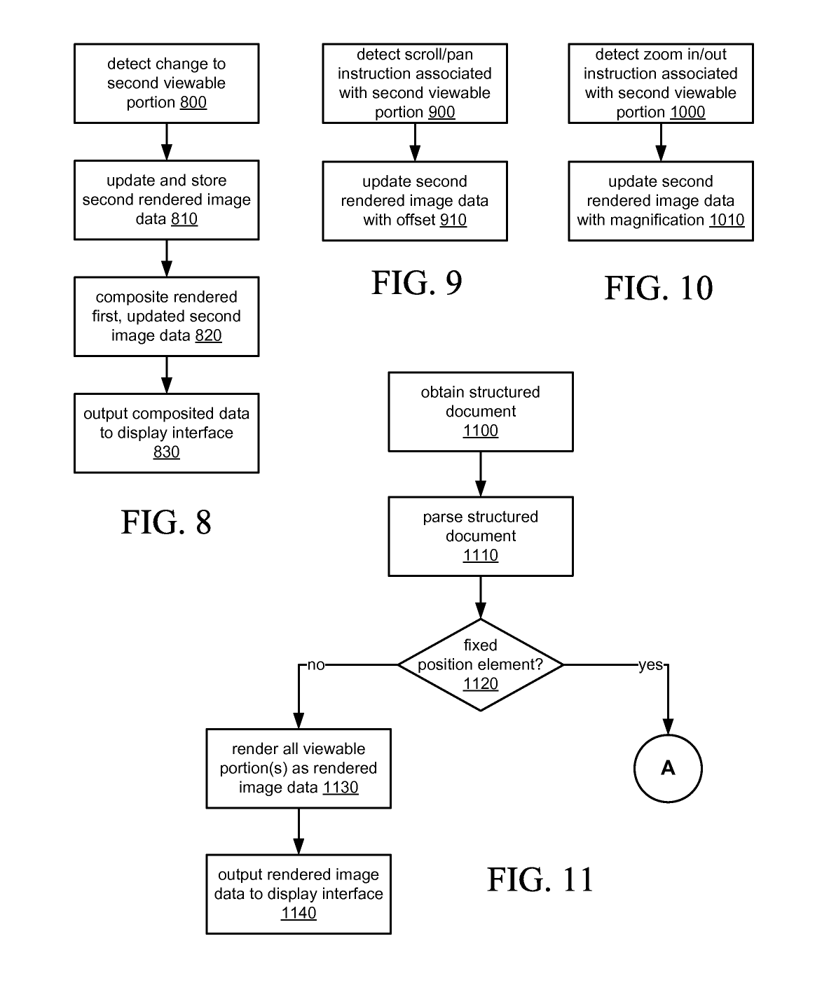

Turning to FIG. 8, once the composited image data has been sent to the display interface 103 and subsequently displayed, an instruction affecting the display of the second viewable region may be detected at 800. This instruction may result from user input of a scroll command, as mentioned above; the instruction may also result from a script executed by the script processor 224 invoking an action such as a scroll action. For example, a webpage may include Javascript, which when executed by the script processor 224, causes one or more content elements to scroll across the display 110 while a fixed position background element remains in its position with respect to the viewport. In response to this detected instruction, transformation instructions for the second rendered image data are determined and stored at 810. Since the first rendered image data represents the fixed position elements, the first rendered image data is not updated in this manner. Then, at 820, the graphics processor module 125 is instructed to composite the first rendered image data and the updated second rendered image data (i.e., the second rendered image data to which the transformation has been applied), and the resultant composited image data is then outputted to the display interface 103 at 830.

Following this process, the layout engine 222 is not required to re-parse the structured document or to regenerate any image data for either the first or second viewable portions of the structured document, because the graphics processor module 125 simply applies a transformation to the existing second rendered image data. Thus, the layout engine 222 need only generate the rendered image data for the fixed and non-fixed viewable regions once for reuse multiple times by the graphics processor module 125.

In some instances, it may be determined by the browser that the transformation to be applied to the second viewable region will require image data for a portion of the structured document that was not yet rendered. In those cases, the layout engine 222 will render at least that missing portion of the structured document for provision to the graphics processor module 125.

FIGS. 9 and 10 further detail the process of FIG. 8 for scroll/pan and zoom in/out commands. As described with reference to FIGS. 3A through 5B, the effect of a scroll instruction applied to the rendered webpage displayed in the viewport is to change the currently displayed portion of the viewable content of the webpage. In the case of a detected scroll instruction 900 (which can include scrolling or panning in the direction of a display axis, as well as at oblique angles to the axis), the second rendered image data is updated by determining an offset, translation vector or value based on the detected scroll command and storing this data in association with the second rendered image data at 910. The graphics processor module 125 is then instructed to apply this offset or other data to the second rendered image data and to re-composite the updated second rendered image data with the first rendered image data.

Turning to FIG. 10, if a zoom in/out command can be applied to separate viewable regions instead of the entire webpage as displayed, when a zoom in/out command is detected for the second viewable region containing non-fixed elements at 1000, the second rendered image data is updated at 1010 by determining and storing a magnification or scaling factor. The graphics processor module 125 is then instructed to apply this magnification factor to the second rendered image data and to recomposite the image data, as before.

If a structured document does not include fixed position elements, it may not be necessary to provide any image data to the graphics processor module 125 for processing. Accordingly, the above process of accelerated compositing using the graphics processor module 125 need only be applied selectively, as illustrated in FIG. 11. At 1100, the structured document is obtained. At 1110, the document is parsed by the layout engine 222, as above. At 1120, it is determined by the layout engine 222 whether any fixed position elements are present in the structured document. If there are no fixed position elements, then the conventional cached image or backing store implementation may be suitable for the document, in which case the layout engine 222 will render all viewable portions of the document as flat image data at 1130, optionally store this image data in the local store 226 or backing store, and then output the rendered image data directly to the display interface 103. However, if there are fixed position elements, then the process continues with branch A (i.e., block 620 of FIG. 6).

The fixed position style directive is thus respected by the browser application 152 and the layout engine 222, without requiring further re-rendering by the layout engine 222 or requiring webpage developers to code content elements differently for display on mobile platforms versus desktop platforms. Further, there is no need to include further directives to invoke compositing by the graphics processor module 125, such as 3D transformation directives or <canvas> elements; it is sufficient that the presence of fixed position elements is detected in the structured document.

As explained above, the embodiments herein should not be construed as being limited to webpages or strict compliance with webpage-related standards. Further, those skilled in the art will appreciate that a layout engine as contemplated above may be invoked by other applications on the electronic device 100 that process structured documents for display.

The systems and methods disclosed herein are presented only by way of example and are not meant to limit the scope of the subject matter described herein. Other variations of the systems and methods described above will be apparent to those in the art and as such are considered to be within the scope of the subject matter described herein. For example, it should be understood that steps and the order of the steps in the processing described herein may be altered, modified and/or augmented and still achieve the desired outcome. Throughout the specification, terms such as “may” and “can” are used interchangeably and use of any particular term should not be construed as limiting the scope or requiring experimentation to implement the claimed subject matter or embodiments described herein.

The systems' and methods' data may be stored in one or more data stores. The data stores can be of many different types of storage devices and programming constructs, such as RAM, ROM, flash memory, programming data structures, programming variables, etc. It is noted that data structures describe formats for use in organizing and storing data in databases, programs, memory, or other computer-readable media for use by a computer program.

Code adapted to provide the systems and methods described above may be provided on many different types of computer-readable media including computer storage mechanisms (e.g., CD-ROM, diskette, RAM, flash memory, computer's hard drive, etc.) that contain instructions for use in execution by a processor to perform the methods' operations and implement the systems described herein.

The computer components, software modules, functions and data structures described herein may be connected directly or indirectly to each other in order to allow the flow of data needed for their operations. Various functional units described herein have been expressly or implicitly described as engines, modules or applications, in order to more particularly emphasize their potentially independent implementation and operation, but these terms are used interchangeably unless otherwise specified. It is also noted that an engine, application, module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The various functional units may be implemented in hardware circuits comprising custom VLSI circuits or gate arrays; field-programmable gate arrays; programmable array logic; programmable logic devices; commercially available logic chips, transistors, and other such components. Modules implemented as software for execution by a processor or processors may comprise one or more physical or logical blocks of code that may be organized as one or more of objects, procedures, or functions. The modules need not be physically located together, but may comprise code stored in different locations, such as over several memory devices, capable of being logically joined for execution. Modules may also be implemented as combinations of software and hardware, such as a processor operating on a set of operational data or instructions.

A portion of the disclosure of this patent document contains material which is or may be subject to one or more of copyright, design patent, industrial design, or unregistered design protection. The rightsholder has no objection to the reproduction of any such material as portrayed herein through facsimile reproduction of the patent document or patent disclosure, as it appears in the Patent and Trademark Office patent file or records, but otherwise reserves all rights whatsoever.

1. A method in an electronic device, the method comprising:
determining that a structured document to be displayed includes at least a first viewable portion having a fixed position in relation to a viewport defined for a display and a second viewable portion;
in response to said determining,
rendering, as first rendered image data, content of the first viewable portion; and
rendering, as second rendered image data, content of the second viewable portion; and
outputting to a display interface a composite image, the composite image having a first composite portion based upon the first rendered image data in the fixed position and a second composite portion based upon at least a portion of the second rendered image data.

2. The method of claim 1, wherein the viewport is defined as a maximum physical display region of the display.

3. The method of claim 1, wherein the viewport is defined as an application window displayed on the display.

4. The method of claim 1, wherein the fixed position of the first viewable portion is defined in the structured document.

5. The method of claim 1, wherein the fixed position of the first viewable portion is defined by a style directive associated with the structured document.

6. The method of claim 5, wherein the structured document is a webpage and the style directive is a position:fixed attribute or a background property having a value of fixed.

7. The method of claim 1, further comprising:
storing the first rendered image data in a first memory allocation of the electronic device; and
separately storing the second rendered image data in a second memory allocation of the electronic device.

8. The method of claim 1, wherein the first rendered image data is associated with a first set of display coordinates and the second rendered image data is associated with a second set of display coordinates.

9. The method of claim 1, wherein the first composite portion includes the first rendered image data applied as a texture to a first surface and the second composite portion includes the second rendered image data as a texture to a second surface, the first surface and the second surface being defined by characteristics of the first viewable portion and second viewable portion, respectively.

10. The method of claim 9, wherein said characteristics include a bounding box defined for each of the first viewable portion and second viewable portion.

11. The method of claim 9, wherein said characteristics include a z-index associated with at least one of the first viewable portion and second viewable portion.

12. The method of claim 1, wherein the first viewable portion is defined as overlaying the second viewable portion.

13. The method of claim 1, further comprising:
detecting a change to the second viewable portion of the outputted composite image;
determining transformation instructions for the second rendered image data in response to said detection; and
outputting to the display a further composite image, the further composite image having the first composite portion based upon the first rendered image data in the fixed position and a further second composite portion based upon at least a portion of the second rendered image data to which the transformation instructions have been applied.

14. The method of claim 13, wherein the change includes a magnification of the content of the second viewable portion.

15. The method of claim 13, wherein the change includes a scroll instruction associated with the content of the second viewable portion.

16. An electronic device comprising:
a display interface;
a processor adapted to process a structured document to be displayed by:
determining that the structured document includes at least a first viewable portion having a fixed position in relation to a viewport defined for a display and a second viewable portion;
in response to said determining,
rendering, as first rendered image data, content of the first viewable portion; and
rendering, as second rendered image data, content of the second viewable portion; and
outputting to the display interface a composite image, the composite image having a first composite portion based upon the first rendered image data in the fixed position and a second composite portion based upon at least a portion of the second rendered image data.

17. The electronic device of claim 16, wherein the processor is further adapted to store the first rendered image data in a first memory allocation of the electronic device, and to separately store the second rendered image data in a second memory allocation of the electronic device.

18. The electronic device of claim 16, wherein the display is integrated in the electronic device.

19. The electronic device of claim 16, wherein the viewport is defined as either a maximum physical display region of the display or an application window displayed on the display.

20. The electronic device of claim 16, wherein the fixed position of the first viewable portion is defined by a style directive associated with the structured document.

21. The electronic device of claim 20, wherein the structured document is a webpage and the style directive is a position:fixed attribute or a background property having a value of fixed.

22. The electronic device of claim 16, wherein the processor is further adapted to:
detect a change to the second viewable portion of the outputted composite image;
determine transformation instructions for the second rendered image data in response to said detection; and
output to the display interface a further composite image, the further composite image having the first composite portion based upon the first rendered image data in the fixed position and a further second composite portion based upon at least a portion of the second rendered image data to which the transformation instructions have been applied.

23. The electronic device of claim 22, wherein the change includes a magnification of the content of the second viewable portion.

24. The electronic device of claim 22, wherein the change includes a scroll instruction associated with the content of the second viewable portion.

25. The electronic device of claim 16, further comprising a second processor adapted to generate the composite image.

26. An electronic device program product comprising a non-transitory electronic device-readable medium bearing code which, when executed by at least one processor of an electronic device, causes the electronic device to:
determine that a structured document to be displayed includes at least a first viewable portion having a fixed position in relation to a viewport defined for a display and a second viewable portion;
in response to said determining,
render, as first rendered image data, content of the first viewable portion; and
render, as second rendered image data, content of the second viewable portion; and
output to a display interface a composite image, the composite image having a first composite portion based upon the first rendered image data in the fixed position and a second composite portion based upon at least a portion of the second rendered image data.
